(19) United States
(12) Patent Application Publication
(10) Pub. No.: US 2019/0229654 A1
(43) Pub. Date: Jul. 25, 2019

(54) CONTROL DEVICE

(71) Applicant: MABUCHI MOTOR CO., LTD., Chiba (JP)

(72) Inventor: Kohei HAMAZAKI, Chiba (JP)

(21) Appl. No.: 16/158,298

(22) Filed: Oct. 12, 2018

(30) Foreign Application Priority Data
Jan. 24, 2018 (JP) 2018-009826

(51) Int. Cl. H02P 6/17; H02P 23/14; H02P 6/28; H02P 27/06

(52) U.S. Cl. CPC H02P 6/17; H02P 23/14; G01D 5/145; H02P 27/06; H02P 6/28

(57) ABSTRACT

A control device that is a control device for a three-phase brushless motor includes: an externally applied voltage acquisition unit that acquires externally applied voltage applied to the three-phase brushless motor; a rotation speed calculation unit that calculates rotation speed of the three-phase brushless motor; a storage unit that stores a voltage advance angle map in which the externally applied voltage and the rotation speed and a voltage advance angle are associated with each other under a condition that a magnetic flux component Id of the magnetic flux component and a torque component of phase current is constant; and a voltage advance angle calculation unit that calculates the voltage advance angle based on the externally applied voltage acquired by the externally applied voltage acquisition unit, the rotation speed calculated by the rotation speed calculation unit, and the voltage advance angle map stored in the storage unit.

### BACKGROUND

### 1. Technical Field

The present disclosure relates to a control device.

### 2. Description of the Related Art

When a three-phase brushless motor is driven by a sine wave, the current value of each of the phases U, V and W is read by a current sensor, and a three-phase to two-phase conversion is performed with respect to the value read by the current sensor in some cases. An optimal advance angle value is calculated from the three-phase to two-phase conversion, and the phase of a sine wave, which is a driving waveform, is determined. In the method for calculating advance angle values using three-phase to two-phase conversion, current sensors for three phases are necessary. The three-phase to two-phase conversion also needs a large amount of calculation; therefore, providing an expensive micro controller unit (MCU) is necessary.

A control device that controls an inverter without using a current sensor is disclosed (for example, JP-A-2004-48868). According to the related art as described in JP-A-2004-48868, the value of the current flowing through the inverter is detected by an inverter current detector and is sampled. According to the related art as described in JP-A-2004-48868, the AC current flowing through the motor is reproduced based on the sampled current value.

### SUMMARY

However, in the related art as described in JP-A-2004-48868, three-phase to two-phase conversion is performed with respect to the reproduced AC current value; therefore, there has been an issue that a calculation amount is still necessary for the calculation of the three-phase to two-phase conversion.

An embodiment of the present disclosure is a control device of a three-phase brushless motor, including: an externally applied voltage acquisition unit that acquires externally applied voltage applied to the three-phase brushless motor; a rotation speed calculation unit that calculates rotation speed of the three-phase brushless motor; a storage unit that stores a voltage advance angle map in which the externally applied voltage and the rotation speed and a voltage advance angle are associated with each other under a condition that a magnetic flux component Id of the magnetic flux component and a torque component of phase current is constant; and a voltage advance angle calculation unit that calculates the voltage advance angle based on the externally applied voltage acquired by the externally applied voltage acquisition unit, the rotation speed calculated by the rotation speed calculation unit, and the voltage advance angle map stored in the storage unit.

According to an embodiment of the present disclosure, in the above control device, the storage unit may store the multiple voltage advance angle maps, and the voltage advance angle calculation unit may select the voltage advance angle map from the multiple voltage advance angle maps stored in the storage unit in accordance with an input value determining an operation state of the three-phase brushless motor, and may calculate the voltage advance angle based on the selected voltage advance angle map.

According to an embodiment of the present disclosure, in the above control device, the input value may be the rotation speed.

According to an embodiment of the present disclosure, in the above control device, the input value may be required torque of the three-phase brushless motor.

The present disclosure can provide a control device that can perform sine wave drive with a small calculation amount.

### BRIEF DESCRIPTION OF THE DRAWINGS

FIG. 1 is a diagram showing an example of a motor control device according to the present embodiment;

FIG. 2 is a diagram showing an example of a configuration of an inverter control device according to the present embodiment; and

FIG. 3 is a diagram showing an example of a voltage advance angle map according to the present embodiment.

### DESCRIPTION OF THE EMBODIMENTS

### Embodiment

An embodiment of the present disclosure will be described below with reference to the drawings.

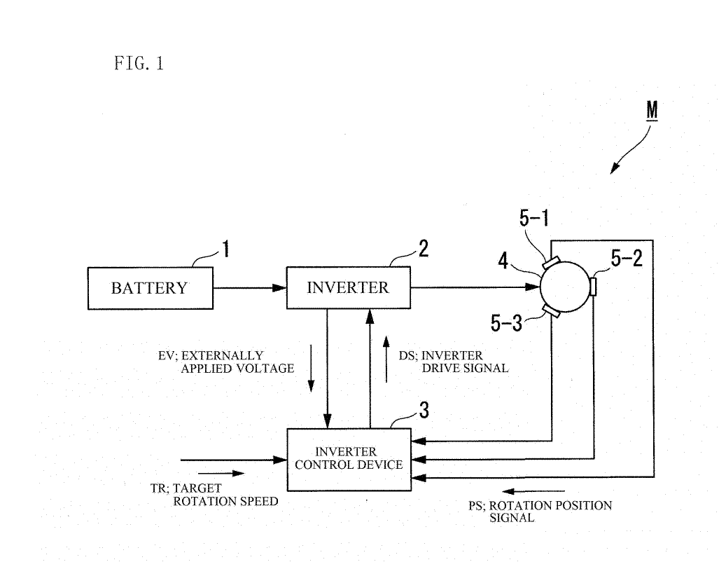

FIG. 1 is a diagram showing an example of a configuration of a motor control device M according to the present embodiment. The motor control device M includes a battery 1, an inverter 2, an inverter control device 3, a brushless motor 4, and position sensors 5-1 to 5-3.

The battery 1 supplies power to the motor control device M. The battery 1 is, for example, a secondary battery such as a nickel-cadmium battery or a lithium ion battery. The battery 1 is not limited to a secondary battery and may be a primary battery such as a dry cell. A DC power supply may also be provided instead of the battery 1.

The inverter 2 rotates the rotor provided in the brushless motor 4 by supplying the power supplied from the battery 1 to the brushless motor 4. The inverter 2 acquires an inverter drive signal DS from the inverter control device 3. The inverter 2 supplies AC power to the brushless motor 4 based on the acquired inverter drive signal DS.

The brushless motor 4 includes a rotor and a drive coil. The brushless motor 4 is, for example, a three-phase brushless motor. The brushless motor 4 rotates the rotor by the suction force or repulsive force caused by the magnetic force generated by the current supplied to the drive coil and the magnetic force of the permanent magnet included in the rotor.

The position sensors 5-1 to 5-3 are provided on the circumference around the rotation axis of the brushless motor 4 every 120 degrees. The position sensors 5-1 to 5-3 are provided with magnetic sensors such as hall elements, and detect the rotation position of the rotor (for example, an electric angle). The position sensors 5-1 to 5-3 detect the rotation position of the brushless motor 4, and they each generate rotation position information indicating the detected rotation position. The position sensors 5-1 to 5-3 each generate a rotation position signal PS, which is a set of three pieces of rotation position information, and supply the generated rotation position signal PS to the inverter control device 3.

The inverter control device 3 controls the inverter 2 by supplying the inverter drive signal DS to the inverter 2.

The inverter control device 3 acquires the rotation position signal PS from the position sensors 5-1 to 5-3. The inverter control device 3 acquires externally applied voltage EV from a voltmeter (not shown) provided on the inverter 2. The externally applied voltage EV is the magnitude (for example, a voltage value) of the DC voltage supplied from the battery 1 to the inverter 2. The inverter control device 3 acquires target rotation speed TR from an operation part (not shown). The target rotation speed TR is a value indicating the rotation number of the brushless motor 4 in a unit time controlled by the motor control device M. The inverter control device 3 generates the inverter drive signal DS based on the rotation position signal PS, the externally applied voltage EV, and the target rotation speed TR. The inverter drive signal DS may be pulse width control or pulse number control.

### {Transition to Sine Wave Drive}

The motor control device M uses the position sensors 5-1 to 5-3, which are hall sensors, to detect the rotation position of the brushless motor 4 as described above. The motor control device M uses hall sensors to detect the rotation position of the brushless motor 4; therefore, it is difficult to detect the accurate rotation position when the brushless motor 4 is stopped. The motor control device M operates the brushless motor 4 by so-called 120-degree energization drive when starting the brushless motor 4 in a stopped state. The motor control device M transits to the sine wave drive when the rotation position becomes predictable from the rotation position signal PS generated by the position sensors 5-1 to 5-3.

Regarding the condition in which the motor control device M transits from 120-degree energization drive to sine wave drive, a predetermined transition condition is followed. The predetermined transition condition includes, for example, when the brushless motor 4 continuously rotates in a constant direction for seven or more turns of an electric angle and the rotation speed of the brushless motor 4 reaches 150 rpm or more. When a predetermined condition is satisfied, the motor control device M transits to the sine wave drive after the predetermined condition is satisfied and the rotation position signal PS is updated.

### {Configuration of Inverter Control Device 3}

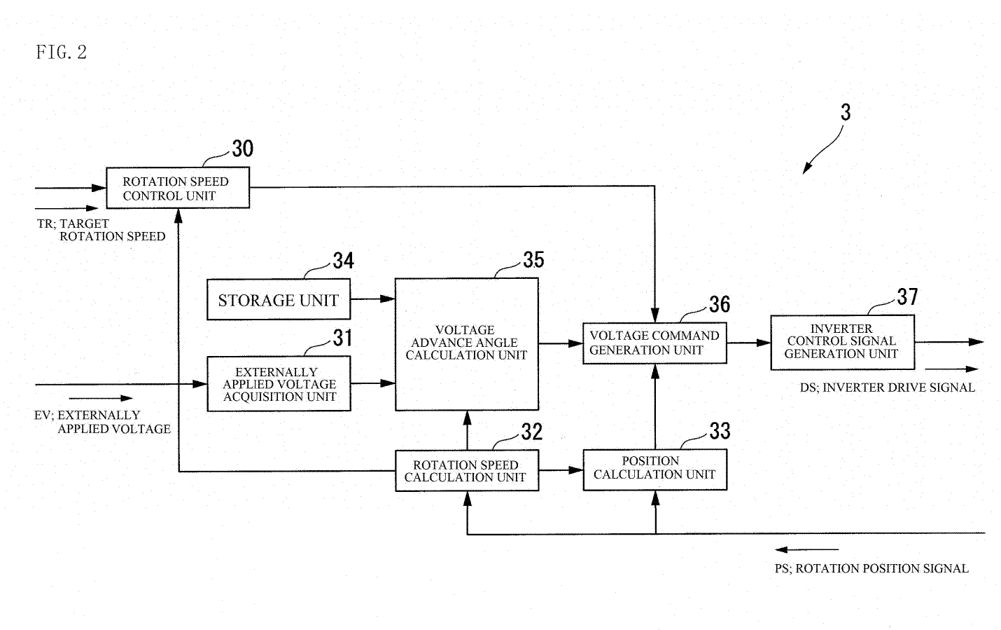

FIG. 2 is a diagram showing an example of a configuration of an inverter control device 3 according to the present embodiment. The inverter control device 3 includes a rotation speed control unit 30, an externally applied voltage acquisition unit 31, a rotation speed calculation unit 32, a position calculation unit 33, a storage unit 34, a voltage advance angle calculation unit 35, a voltage command generation unit 36, and an inverter control signal generation unit 37.

The rotation speed control unit 30 acquires the target rotation speed TR from a host device (not shown). The rotation speed control unit 30 acquires the rotation speed of the brushless motor 4 from the rotation speed calculation unit 32. The rotation speed control unit 30 compares the target rotation speed TR and the acquired rotation speed, and generates voltage amplitude based on the deviation between the target rotation speed TR and the acquired rotation speed. The rotation speed control unit 30 supplies the generated voltage amplitude to the voltage command generation unit 36.

The externally applied voltage acquisition unit 31 acquires the externally applied voltage EV from a voltmeter (not shown) provided on the inverter 2. That is, the externally applied voltage acquisition unit 31 acquires the externally applied voltage EV applied to the brushless motor 4. The externally applied voltage acquisition unit 31 supplies the acquired externally applied voltage EV to the voltage advance angle calculation unit 35.

The rotation speed calculation unit 32 acquires the rotation position signal PS. The rotation speed calculation unit 32 calculates the rotation speed of the brushless motor 4 based on the three pieces of rotation position information indicated by the rotation position signal PS. The rotation speed calculation unit 32 supplies the calculated rotation speed of the brushless motor 4 to the voltage advance angle calculation unit 35 and the position calculation unit 33.

The position calculation unit 33 acquires the rotation position signal PS. The position calculation unit 33 calculates the rotation position of the brushless motor 4 based on the acquired rotation position signal PS and the rotation speed of the brushless motor 4 acquired from the rotation speed calculation unit 32. The position calculation unit 33 supplies the calculated rotation angle of the brushless motor 4 to the voltage command generation unit 36.

A voltage advance angle map 340 is stored in the storage unit 34. The voltage advance angle map 340 is a map in which the externally applied voltage EV and the rotation speed and the voltage advance angle of the brushless motor 4 are associated with each other under the condition that a magnetic flux component Id of the magnetic flux component and torque component of the phase current is constant. The voltage advance angle map 340 holds values of voltage advance angles corresponding to the operation state of the brushless motor 4.

The voltage advance angle calculation unit 35 acquires the voltage advance angle map 340 from the storage unit 34. The voltage advance angle calculation unit 35 acquires the externally applied voltage EV from the externally applied voltage acquisition unit 31. The voltage advance angle calculation unit 35 acquires the rotation speed of the brushless motor 4 from the rotation speed calculation unit 32. The voltage advance angle calculation unit 35 calculates the voltage advance angle based on the externally applied voltage EV calculated by the externally applied voltage acquisition unit 31, the rotation speed calculated by the rotation speed calculation unit 32, and the voltage advance angle map 340. The voltage advance angle calculation unit 35 supplies the calculated voltage advance angle to the voltage command generation unit 36.

The voltage command generation unit 36 acquires the voltage amplitude from the rotation speed control unit 30. The voltage command generation unit 36 acquires the rotation angle of the brushless motor 4 from the position calculation unit 33. The voltage command generation unit 36 acquires the voltage advance angle from the voltage advance angle calculation unit 35. The voltage command generation unit 36 generates a voltage command signal Vu of the U-phase of the brushless motor 4 based on Equation (1) using the acquired voltage amplitude, the acquired rotation angle, and the acquired voltage advance angle.

[Mathematical 1]

Vu=Va cos(θ+α) (1)

where Va represents the voltage amplitude. The symbol θ represents the rotation angle. The symbol α represents the voltage advance angle.

The voltage command generation unit 36 generates a voltage command signal Vv of the V-phase of the brushless motor 4 by applying the phase difference of 120 degrees to the voltage command signal Vu expressed by Equation (1). The voltage command generation unit 36 generates a voltage command signal Vw of the W-phase of the brushless motor 4 by applying the phase difference of 240 degrees to the voltage command signal Vu expressed by Equation (1). The voltage command generation unit 36 supplies the generated voltage command signal Vu, voltage command signal Vv, and voltage command signal Vw to the inverter control signal generation unit 37.

The inverter control signal generation unit 37 acquires the voltage command signal Vu, the voltage command signal Vv, and the voltage command signal Vw from the voltage command generation unit 36. The inverter control signal generation unit 37 generates the inverter drive signal DS based on the acquired voltage command signal Vu, voltage command signal Vv, and voltage command signal Vw. The inverter control signal generation unit 37 supplies the generated inverter drive signal DS to the inverter 2 to control the inverter 2.

In Equation (1), the phase of the voltage command signal Vu advances by the voltage advance angle; therefore, the inverter control device 3 can make the phase of the phase current flowing through the winding of the coil of the brushless motor 4 coincide with the phase of the induced voltage generated in the winding. Thus, the efficiency of the brushless motor 4 can be improved.

In the sine wave drive of the three-phase brushless motor, the voltage advance angle and the phase of voltage at the time of sine wave output are calculated. In the related art, vector control using three-phase to two-phase conversion is performed for the calculation of the voltage advance angle and the phase of voltage. However, three-phase to two-phase conversion needs large computation capacity; therefore, the use of a high-performance microcomputer is necessary, increasing the costs. The inverter control device 3 according to the present embodiment performs no three-phase to two-phase conversion, and acquires the value of the voltage advance angle in accordance with the operation state of the brushless motor 4 from the voltage advance angle map 340 instead of the three-phase to two-phase conversion.

Here, a method for creating the voltage advance angle map 340 will be described.

### {Creation of Voltage Advance Angle Map}

In the creation of the voltage advance angle map 340, the rotation speed and the externally applied voltage EV are used as the variables that determine the operation state of the brushless motor 4. Under the assumption that the brushless motor 4 is in a steady state, a voltage advance angle is obtained from the voltage equation of the brushless motor 4. However, the value of the phase current Id, which is the magnetic flux component of the magnetic flux component and torque component of phase current is a constant.

When the voltage equation of the brushless motor 4 is expressed on an axis d and an axis q in the three-phase to two-phase conversion, Equation (2) and Equation (3) can be obtained. Hereinafter, when values are expressed on the axis d and the axis q in the three-phase to two-phase conversion, they may be referred to as the values expressed on axes dq.

$$\begin{matrix}[ Mathematical 2 ] & \\ Vd = IdR - IqLq ω + ( \frac{d}{dt} Id ) Ld & ( 2 ) \\ [ Mathematical 3 ] & \\ Vq = IqR + IdLd ω + ψω + ( \frac{d}{dt} Iq ) Lq & ( 3 )\end{matrix}$$

where voltage Vd and voltage Vq are values representing the externally applied voltage EV on the axes dq. The unit of the voltage Vd and the voltage Vq is a bolt. The phase current Id and phase current Iq are values representing the phase current on the axes dq. That is, the phase current Id is the magnetic flux component of the magnetic flux component and torque component of phase current. The phase current Iq is the torque component of the magnetic flux component and torque component of phase current. The unit of the phase current Id and the phase current Iq is an ampere. Phase inductance Ld and phase inductance Lq are values representing the winding phase inductance of the brushless motor 4 on the axes dq. The unit of the phase inductance Ld and the phase inductance Lq is a henry. Resistance R is the winding phase resistance of the brushless motor 4. The unit of the resistance R is an ohm. An induced voltage constant w is the induced voltage constant of the brushless motor 4. The unit of the induced voltage constant w is a bolt second. Rotation speed w is the rotation speed of the brushless motor 4. The unit of the rotation speed w is a radian per second.

When a steady state is assumed in Equation (2) and Equation (3), the differential value related to the time of the phase current can be set to zero. When Equation (2) and Equation (3) are solved simultaneously for the phase current Id and the phase current Iq under the condition in which a steady state is assumed, Equation (4) and Equation (5) below can be obtained.

$$\begin{matrix}[ Mathematical 4 ] & \\ Id = \frac{VdR + Lq ω Vq - ψ Lq {ω}^{2}}{{R}^{2} + LdLq {ω}^{2}} & ( 4 ) \\ [ Mathematical 5 ] & \\ Iq = \frac{- ( ψω - Vq ) R - Ld ω Vd}{{R}^{2} + LdLq {ω}^{2}} & ( 5 )\end{matrix}$$

Here, when the voltage Vd and the voltage Vq are expressed with magnitude Vdq and a voltage phase α, Equation (6) and Equation (7) can be obtained.

[Mathematical 6]

Vd=−sin(α)Vdq (6)

[Mathematical 7]

Vq=cos(α)Vdq (7)

When Equation (6) and Equation (7) are assigned to Equation (4) and Equation (5), Equation (8) and Equation (9) can be obtained.

$$\begin{matrix}[ Mathematical 8 ] & \\ Id ( α ) = \frac{- sin ( α ) VdqR + cos ( α ) Lq ω Vdq - ψ Lq {ω}^{2}}{{R}^{2} + LdLq {ω}^{2}} & ( 8 ) \\ [ Mathematical 9 ] & \\ Iq ( α ) = \frac{sin ( α ) Ld ω Vdq - ( ψω - cos ( α ) Vdq ) R}{{R}^{2} + LdLq {ω}^{2}} & ( 9 )\end{matrix}$$

In Equation (8) and Equation (9), the phase current Id and the phase current Iq are expressed by the resistance R, the phase inductance Ld, the phase inductance Lq, the induced voltage constant ψ, the magnitude Vdq and the voltage phase α of the voltage Vd and the voltage Vq, and the rotation speed ω.

When Equation (8) is modified, Equation (10) can be obtained.

$$\begin{matrix}[ Mathematical 10 ] & \\ cos ( α ) Lq ω - sin ( α ) R = \frac{Id ( {R}^{2} + LdLq {ω}^{2} ) + ψ Lq {ω}^{2}}{Vdq} & ( 10 )\end{matrix}$$

When both sides of Equation (10) are divided by a common factor, Equation (11) can be obtained.

$$\begin{matrix} [ Mathematical 11 ] & \\ \frac{cos ( α ) Lq ω}{\sqrt{{R}^{2} + {Lq}^{2} {ω}^{2}}} - \frac{sin ( α ) R}{\sqrt{{R}^{2} + {Lq}^{2} {ω}^{2}}} = \frac{Id ( {R}^{2} + LdLq {ω}^{2} ) + ψ Lq {ω}^{2}}{Vdq \sqrt{{R}^{2} + {Lq}^{2} {ω}^{2}}} & ( 11 )\end{matrix}$$

Here, phase β satisfying Equation (12), Equation (13), Equation (14), and Equation (15) below is introduced.

$$\begin{matrix}[ Mathematical 12 ] & \\ sin ( β ) = \frac{R}{\sqrt{{R}^{2} + {Lq}^{2} {ω}^{2}}} & ( 12 ) \\ [ Mathematical 13 ] & \\ cos ( β ) = \frac{Lq ω}{\sqrt{{R}^{2} + {Lq}^{2} {ω}^{2}}} & ( 13 ) \\ [ Mathematical 14 ] & \\ tan ( β ) = \frac{R}{Lq ω} & ( 14 ) \\ [ Mathematical 15 ] & \\ β = arctan ( \frac{R}{Lq ω} ) & ( 15 )\end{matrix}$$

When the phase β is used for compositions of trigonometric functions, Equation (11) can be expressed with one trigonometric function as shown in Equation (16).

$$\begin{matrix}[ Mathematical 16 ] & \\ cos ( α + β ) = \frac{Id ( {R}^{2} + LdLq {ω}^{2} ) + ψ Lq {ω}^{2}}{Vdq \sqrt{{R}^{2} + {Lq}^{2} {ω}^{2}}} & ( 16 )\end{matrix}$$

When the phase of the trigonometric function of Equation (16) is solved, Equation (17) can be obtained.

$$\begin{matrix}[ Mathematical 17 ] & \\ α + β = arccos ( \frac{Id ( {R}^{2} + LdLq {ω}^{2} ) + ψ Lq {ω}^{2}}{Vdq \sqrt{{R}^{2} + {Lq}^{2} {ω}^{2}}} ) & ( 17 )\end{matrix}$$

When the voltage phase α of Equation (17) is solved, Equation (18) can be obtained.

$$\begin{matrix}[ Mathematical 18 ] & \\ α = arccos ( \frac{Id ( {R}^{2} + LdLq {ω}^{2} ) + ψ Lq {ω}^{2}}{Vdq \sqrt{{R}^{2} + {Lq}^{2} {ω}^{2}}} ) - arctan ( \frac{R}{Lq ω} ) & ( 18 )\end{matrix}$$

When the phase current Id, the resistance R, the phase inductance Ld, the phase inductance Lq, the induced voltage constant ψ, the magnitude Vdq of the voltage Vd and the voltage Vq, and the rotation speed w are assigned to Equation (18), the voltage phase α can be obtained. Therefore, the voltage advance angle calculation unit 35 can calculate the voltage phase α as a voltage advance angle based on the two-dimensional map, that is, the voltage advance angle map 340.

In the motor control device M, the voltage advance angle map 340 created beforehand is stored in the storage unit 34. In the motor control device M, the voltage advance angle is calculated based on the externally applied voltage EV, the rotation speed, and the voltage advance angle map 340. Here, the externally applied voltage EV is acquired by the externally applied voltage acquisition unit 31. In addition, the rotation speed is calculated by the rotation speed calculation unit 32 based on the rotation position signal PS. Thus, the motor control device M can drive the brushless motor 4 by a sine wave without providing a current sensor that detects the phase current of the brushless motor 4. However, the motor control device M may be provided with a current sensor that detects the phase current of the brushless motor 4 for the purpose of detecting malfunction.

In the motor control device M, three-phase to two-phase conversion in vector control is unnecessary; therefore, the computation amount becomes smaller when the motor control device M is realized by a microcomputer compared with the case in which computation for three-phase to two-phase conversion is performed.

Here, the resistance R, the phase inductance Ld, the phase inductance Lq, and the induced voltage constant w, which are used to create the voltage advance angle map 340, are referred to as motor constants.

### {Voltage Advance Angle Map}

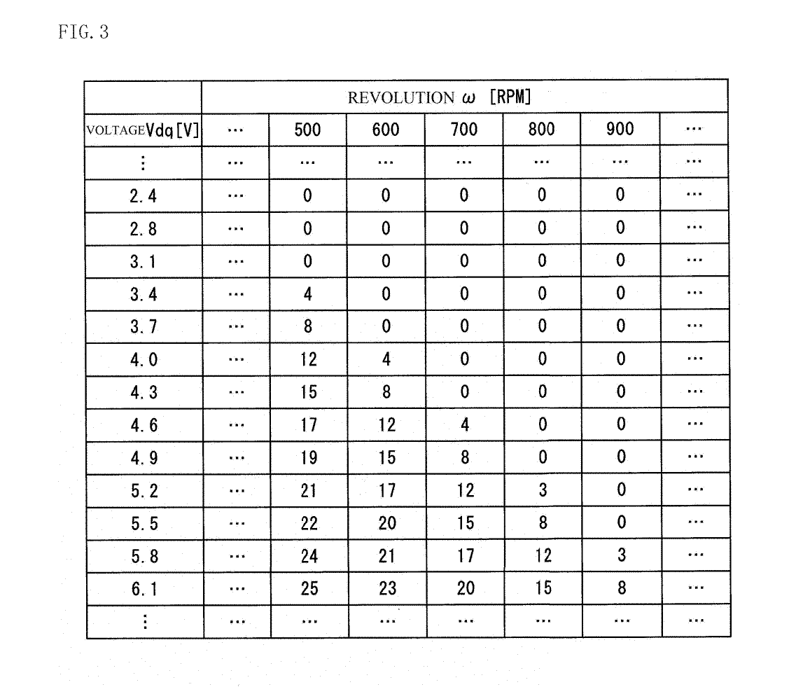

FIG. 3 is a diagram showing an example of a voltage advance angle map 340 according to the present embodiment. In the voltage advance angle map 340, the values of the voltage phase α using Equation (18) with respect to the motor constants in FIG. 3 are held for the combination of the output voltage and the rotation speed. However, in FIG. 3, the values of the voltage phase α are expressed by values in the circular method. In addition, the selectable advance angle value is per 1°, which is resolution of the sine table; therefore, FIG. 3 indicates integers obtained by rounding off the voltage phase α calculated with Equation (18).

Depending on the relationship between the output voltage and the rotation speed, when the voltage phase α is calculated with Equation (17), no solution can be obtained under some conditions. For example, in the low-output high rotation speed, the inverse cosine function of Equation (17) diverges and no solution can be obtained under some conditions. This is physically equivalent to a reverse load state, which means that it is difficult to control the current flowing out by the induced voltage of the brushless motor 4 in a manner that the condition that the value of the phase current Id becomes a constant is satisfied because of the low output voltage. In a reverse load state, control different from sine wave driving such as short brake operation between terminals is performed; therefore, in the voltage advance angle map 340 in FIG. 3, conditions in which no solution can be obtained are indicated by 0° uniformly.

The voltage advance angle map 340 shown in FIG. 3 is an example of a map in the case in which the value of the phase current Id is a constant, and is a map corresponding to a weak field state. The voltage advance angle map 340 may be created for the case in which the value of the phase current Id is zero particularly.

In the voltage advance angle map 340, the voltage phase α is held for a total of 1845 combinations of output voltage and rotation speed for example; however, the number of the combination of output voltage and rotation speed can be changed in accordance with the capacity of the storage unit 34.

In addition, the voltage advance angle calculation unit 35 may calculate the value obtained by linearly interpolating the value of the voltage phase α that can be obtained from the voltage advance angle map 340 in accordance with the output voltage and the rotation speed as the value of the voltage advance angle.

### {Conclusion}

As described above, the control device (motor control device M) according to the present embodiment includes the externally applied voltage acquisition unit 31, the rotation speed calculation unit 32, the storage unit 34, and the voltage advance angle calculation unit 35.

The externally applied voltage acquisition unit 31 acquires the externally applied voltage EV applied to the brushless motor 4.

The rotation speed calculation unit 32 calculates the rotation speed of the brushless motor 4.

The storage unit 34 stores the voltage advance angle map 340 in which the externally applied voltage EV and the rotation speed and the voltage advance angle are associated with each other under the condition that the magnetic flux component Id of the magnetic flux component and torque component of phase current is constant.

The voltage advance angle calculation unit 35 calculates the voltage advance angle based on the externally applied voltage EV acquired by the externally applied voltage acquisition unit 31, the rotation speed calculated by the rotation speed calculation unit 32, and the voltage advance angle map 340 stored in the storage unit 34.

With this configuration, the control device (motor control device M) according to the present disclosure can calculate the voltage advance angle based on the voltage advance angle map 340 instead of computing three-phase to two-phase conversion in the vector control. Therefore, the calculation amount for sine wave drive can be reduced compared with the case in which three-phase to two-phase conversion is computed.

### {Switching Multiple Voltage Advance Angle Maps}

In the above embodiment, the case in which the storage unit 34 stores one voltage advance angle map 340 has been described; however, the storage unit 34 may store multiple voltage advance angle maps. When multiple voltage advance angle maps are stored in the storage unit 34, the voltage advance angle calculation unit 35 selects a voltage advance angle map from the multiple voltage advance angle maps stored in the storage unit 34 in accordance with the input value determining the operation state of the brushless motor 4, and calculates the voltage advance angle based on the selected voltage advance angle map. Here, the input value for determining the operation state of the brushless motor 4 is, for example, the target rotation speed TR and the required torque.

When the voltage advance angle calculation unit 35 selects a voltage advance angle map from the multiple voltage advance angle maps in accordance with the target rotation speed TR, the multiple voltage advance angle maps for each range of the rotation speed are stored in the storage unit 34. The voltage advance angle calculation unit 35 acquires the voltage advance angle map for calculating the voltage advance angle from the multiple voltage advance angle maps in accordance with the target rotation speed TR acquired from a host device (not shown).

When the voltage advance angle calculation unit 35 selects a voltage advance angle map from the multiple voltage advance angle maps in accordance with the required torque, the multiple voltage advance angle maps for each required torque are stored in the storage unit 34. The phase current is decomposed into a magnetic flux component and a torque component in the three-phase to two-phase conversion; therefore, the multiple voltage advance angle maps for each required torque is the multiple voltage advance angle maps created for each magnetic flux component of the phase current. The multiple voltage advance angle maps are created for each value of the magnetic flux component Id of the magnetic flux component and torque component of phase current. The voltage advance angle calculation unit 35 acquires a voltage advance angle map for calculating the voltage advance angle from the multiple voltage advance angle maps in accordance with the required torque acquired from a host device (not shown).

With this configuration, the motor control device M according to the present embodiment can calculate the voltage advance angle based on the voltage advance angle map selected in accordance with the operation state of the brushless motor 4. Therefore, voltage advance angles can be calculated more appropriately compared with the case in which voltage advance angles are calculated based on one voltage advance angle map.

In addition, the motor control device M according to the present embodiment selects a voltage advance angle map from the multiple voltage advance angle maps stored in the storage unit 34 in accordance with the rotation speed of the brushless motor 4. Therefore, the voltage advance angle can be calculated by selecting the voltage advance angle map having the calculated rotation speed in the range of the rotation speed even when the calculated rotation speed is out of the range of the rotation speed of one voltage advance angle map.

In addition, the motor control device M according to the present embodiment selects the voltage advance angle map from the multiple voltage advance angle maps stored in the storage unit 34 in accordance with the required torque of the brushless motor 4. Therefore, voltage advance angles can be calculated more appropriately compared with the case in which the voltage advance angle map created in accordance with specific required torque is just used.

In the above, the embodiment of the present disclosure has been described in detail with reference to the drawings; however, the specific configuration is not limited to this embodiment and may be modified as necessary without deviating from the purpose and scope of the present disclosure.

Each of the above devices has a computer inside. The process of the processing of each of the above devices is stored in a computer-readable recording medium in the form of programs. The programs are read and executed by computers, and thus, the above processing is performed. Here, a computer-readable recording medium includes a magnetic disk, a magneto-optical disk, a CD-ROM, a DVD-ROM, and a semiconductor memory. In addition, the computer program may be distributed to a computer through a communication line, and the computer receiving the distribution may execute the program.

The above program may also be used to realize a part of the functions described above. Furthermore, the functions described above may be realized in combination with the programs already recorded in the computer system, which is the so-called difference file (difference program).

### REFERENCE SIGNS LIST

M motor control device
1 battery
2 inverter
3 inverter control device
4 brushless motor
5-1 position sensor
5-2 position sensor
5-3 position sensor
EV externally applied voltage
DS inverter drive signal
TR target rotation speed
PS rotation position signal
30 rotation speed control unit
31 externally applied voltage acquisition unit
32 rotation speed calculation unit
33 position calculation unit
34 storage unit
35 voltage advance angle calculation unit
36 voltage command generation unit
37 inverter control signal generation unit
340 voltage advance angle map

1. A control device of a three-phase brushless motor, comprising:
an externally applied voltage acquisition unit that acquires externally applied voltage applied to the three-phase brushless motor;
a rotation speed calculation unit that calculates rotation speed of the three-phase brushless motor;
a storage unit that stores a voltage advance angle map in which the externally applied voltage and the rotation speed and a voltage advance angle are associated with each other under a condition that a magnetic flux component Id of the magnetic flux component and a torque component of phase current is constant; and
a voltage advance angle calculation unit that calculates the voltage advance angle based on the externally applied voltage acquired by the externally applied voltage acquisition unit, the rotation speed calculated by the rotation speed calculation unit, and the voltage advance angle map stored in the storage unit.

2. The control device according to claim 1, wherein
the storage unit stores the multiple voltage advance angle maps, and
the voltage advance angle calculation unit selects the voltage advance angle map from the multiple voltage advance angle maps stored in the storage unit in accordance with an input value determining an operation state of the three-phase brushless motor, and calculates the voltage advance angle based on the selected voltage advance angle map.

3. The control device according to claim 2, wherein
the input value is the rotation speed.

4. The control device according to claim 2, wherein
the input value is required torque of the three-phase brushless motor.
